(19) United States
(12) Patent Application Publication
(10) Pub. No.: US 2006/0017244 A1
(43) Pub. Date: Jan. 26, 2006

(54) Inner rolling platform form for moving a rigid conainer comprising a positioning receptacle

(76) Inventor: Clemente Jesus Sanchez Velasco, Granada (ES)

Correspondence Address: OSTROLENK FABER GERB & SOFFEN, 1180 AVENUE OF THE AMERICAS, NEW YORK, NY, 100368403, US

(21) Appl. No.: 10/527,000

(22) PCT Filed: Sep. 4, 2003
(86) PCT No.: PCT/ES03/00541

§ 371 Date: Aug. 5, 2005

(30) Foreign Application Priority Data
Sep. 5, 2002 (ES) P20022028

(51) Int. Cl. B62B 1/00

(52) U.S. Cl. 280/47.26

(57) ABSTRACT

The present invention refers to the process of optimization of the design and production of the inner rolling platform and of the rigid container, based on providing a selection of geometric parameters of both constructive conformations that jointly they must transfer you, so that, act the internal mechanism correctly for inclination of the insert container and extraction of the internal rolling platform in the mentioned rigid container. The inner rolling platform when using the internal mechanism of inclination of the container whose essential interest resides in that it allows him to be located and extracted in the rigid container comprising a positioning receptacle, of plane-concave section, without being necessary to lift it of the floor, coarse with inclining it lightly, so that when the rigid container this vertical one, is sustained alone for their concave inferior base inside the central hole of the circular crown of the inner rolling platform, allowing a firm, stable and sure combined rolling. This characteristic is fundamental, because starting from a design optimized group of the holder of location of the rigid container and of the inner rolling platform, they can be configured and manufactured in a simple and reliable way, guaranteeing the indeformabilidad of both and a sure use, allowing a reduction of producing costs and also, of use when making that the installation and extraction of the internal rolling platform, be an activity without almost effort, minimizing the bony and muscular tensions of the extremities and lumbar area of the back.

### OBJECT OF THE INVENTION

The present invention relates to the process of optimization of the design and production of the inner rolling platform and of the rigid container, based in to provide a selection of geometric parameters of both conformations constructive that jointly they must transfer you, so that, act correctly the internal mechanism for inclination of the insert container and extraction of the inner rolling platform in the mentioned rigid container.

The inner rolling platform when using the internal mechanism of inclination of the container whose essential interest resides in that it allows him to be located and extracted in the rigid container comprising a positioning receptacle, of section plane-concave, without being necessary to lift it of the floor, coarse with inclining it lightly, so that when the rigid container this vertical one, is sustained alone for their concave inferior base inside the central hole of the circular crown of the inner rolling platform, allowing a firm, stable and sure combined rolling.

This characteristic is fundamental, because starting from an optimized design group of the holder of location of the rigid container and of the inner rolling platform, they can be configured and manufactured in a simple way and reliable, guaranteeing the indeformabilidad of both and a sure use, allowing a reduction of producing costs and also, of use when making that the installation and extraction of the internal rolling platform, be an activity without almost effort, minimizing the bony and muscular tensions of the extremities and lumbar area of the back.

### PRIOR ART OF THE INVENTION

The main characteristic of inner rolling platform is that one can to install and to extract with a slight basculación, of the whole rigid, leaning container in the floor and without having to lift it.

Numerable types of conventional rolling platforms are known for the transfer of rigid containers, but all they present a great one use of difficulty, increased by the high weight of the containers when they are loaded, causing an intense effort in the moment of their location and external retreat in the rigid container, either of the type of recipients to metallic pressure and also, in those that are not pressurized neither metallic, having them to get up and to specify the correct situation of the outlying hoop to circulate of the base of the container, until being able to be deposited on a narrow fringe of it crowns to circulate, above the rolling platforms or in the case of their extraction, to put the contender in the floor, by means of their rising you it removes of above the conventional rolling platform and separating it, he/she puts on in floor.

As he can turn it, for example, in the descriptions contained in those Models of Utility are ES 0160222 U, it is ES 0163942 U, it is ES 0169949 U and in those Patent DE 518919, U.S. Pat. No. 2,917,769, U.S. Pat. No. 4,544,173 and U.S. Pat. No. 5,145,311, U.S. Pat. No. 5,931,149 and U.S. Pat. No. 6,293,273.

The solicitor doesn't know the documented existence of any invention of rolling platform that acts supporting the rigid container, only, supported by their concave inferior base and that, also, use the mechanism intern for inclination of the insert container and extraction of the inner rolling platform, as characteristic and improvements that it prepares the object of the present invention.

A configuration of support group is known in a platform type rolling, in which is sustained the concave base of the container so much, supported for a tiny surface, as the periphery of the plane border of the circular hoop of support in the floor of the rigid container, and that to install it and to extract you he has to lift the container and to specify the adjustment of their outlying hoop, until to make it coincide with a narrow and narrow fringe that also, this located in a reduced area, where one has to deposit with maxim difficulty and effort, just as, it is described in the Models of Utility it is ES 0155259 U, It is ES 0160222 U and it is ES 0169949 U.

Or, the rigid container being, only, sustained in the rolling platform on the outlying plane border of the circular hoop of support in the floor of the one container, just as it is described in the Model of Utility it is ES 0163492 U, it is ES 0169803 U and it is ES 0275089 U and in the Patents DE 518919, U.S. Pat. No. 266,655, U.S. Pat. No. 2,917,769, U.S. Pat. No. 4,544,173, U.S. Pat. No. 5,931,149 and U.S. Pat. No. 6,293,273.

The prior art of different rolling platforms that in these documents they are described, they remain immobile during their different anchorage processes in their respective containers, except in the one referred in the Patent U.S. Pat. No. 5,931,149, where rolling platform and container tilt outwardly in the moment of its joining, just as U.S. Pat. No. 1,706,253 happens in the Patents, U.S. Pat. No. 1,706,267, U.S. Pat. No. 1,719,763, U.S. Pat. No. 2,215,529, U.S. Pat. No. 2,723,864, U.S. Pat. No. 3,826,512, U.S. Pat. No. 4,318,655 and U.S. Pat. No. 6,742,790

On the other hand, the invention that here is described of the rolling platform it interns, their basculación takes place inwardly inside the holder of location, without any external participation, because automatically she gets up and she goes down from the floor to the concave inferior base and vice versa, during the trial of the one internal mechanism of anchorage and separation in the positioning receptacle of the one rigid container that is carried out supporting, only and gradually, their base inferior concave in the central hole of the circular crown of the inner rolling platform.

The use of the inner rolling platform is applicable to the recipients to metallic pressure or rigid containers with positioning receptacle existent in the market that sually, they are utilized containers for the one storage and transport of pressurized liquids or of liquefied gases, although the existence of what is denominated location holder in this invention and to the one that he is given a new utility, in alone origin it is consequence of a function of protection of their concave inferior base and of stabilization of the support in the floor, as she can US it turns in the Patents U.S. Pat. No. 3,348,721, U.S. Pat. No. 3,505,536, U.S. Pat. No. 3,747,799, U.S. Pat. No. 3,840,141 and U.S. Pat. No. 6,293,273.

The invention that here is described, wide the possibility to use the internal rolling platform to other types of rigid containers, besides those pressurized, transforming their conventional support bases in the floor in positioning receptacles, maintaining their capacity support in the floor and of piling up that they can be seen in certain Patents, such as; U.S. Pat. No. 2,272,447, U.S. Pat. No. 2,447,300, U.S. Pat. No. 2,635,775, U.S. Pat. No. 3,235,094, U.S. Pat. No. 3,854,582 and U.S. Pat. No. 4,981,412.

The simplicity of the design and of the productive process, use easiness with minimum effort of the inner rolling platform, contrasts with the difficulties of use and great required effort, of the rolling platforms conventional for the different types of conventional rigid containers, as the conventional cars with four or three wheels that use complex mechanisms to run off with from the floor to the heavy containers to be able to them then to displace, like it is described in the Model of Utility ES 1045813 U and the following Patent U.S. Pat. No. 2,360,858, U.S. Pat. No. 2,635,775, U.S. Pat. No. 3,587,892 and U.S. Pat. No. 5,122,027 or well, in other cases they must turn you jointly, the car transporter and the one container until the wheels contact with the floor like it is described in the Patents, such as; U.S. Pat. No. 460,250, U.S. Pat. No. 1,738,096, U.S. Pat. No. 1,866,887 and U.S. Pat. No. 2,160,041.

In the case with two wheels must lift the heavy container for to place it in the base of the car and later on, to turn car jointly and container for their transfer, supporting the effort of sustaining the container inclined on the car and of their displacement, examples of both stocks you they describe in the Model of Utility it is ES 0292289 U and the Patents GB 1025705, GB 2069454, U.S. Pat. No. 879,914, U.S. Pat. No. 957,840, U.S. Pat. No. 1,300,567, U.S. Pat. No. 1,517,901, U.S. Pat. No. 1,704,769, U.S. Pat. No. 1,719,763, U.S. Pat. No. 1,820,728, U.S. Pat. No. 2,447,300, U.S. Pat. No. 2,272,447, U.S. Pat. No. 2,650,834, U.S. Pat. No. 2,723,864, U.S. Pat. No. 3,075,662, U.S. Pat. No. 3,503,623, U.S. Pat. No. 3,845,968, U.S. Pat. No. 3,376,986, U.S. Pat. No. 4,802,681 and U.S. Pat. No. 4,981,421.

### DESCRIPTION OF THE INVENTION

The present invention is a system whose fundamental internal mechanism for inclination of the container, it allows the placement and extraction of an inner rolling platform in a rigid container, with an appropriate one positioning receptacle, to be able to transfer it without having to lift it of the one floor.

The inner rolling platform it composes of a base with form of cylindrical cupel, of little depth whose diameter operative maximum will be 10% smaller that the interior diameter of the plane base of establishment in the floor of the rigid container.

The cylindrical cupel, in the center of its support base, has a wide one hole, of minimum diameter of at least half of that of the cupel, with a wide one inclined outlying area, of pending equal to that of the concave inferior base of the container and with a difference between their diameters exterior and interior of at least 12%.

The angular similarity of the inclined sections of establishment of the inner rolling platform and of the concave area of the container, it allows, that both elements are sustained in a stable, firm and sure way.

Another essential parameter of the inner rolling platform is its height functional total, that is to say with the wheels installed in their crown area to circulate, with a minimum of four directional or fixed wheels, by means of riveted or by means of screwed union, in a perpendicular and symmetrical way, counting also; the grosor of the construction material of the cylindrical cupel, the height of establishment of the inner rolling platform in the concave inferior base of the one container, determined by the dimension of the interior diameter of the central hole of the inclined profile that she must enter in the periphery of the concave inferior base of the one container, until 20% of the arrow of their segment of a circle, and finally, the height free of the inferior border of the container to the floor, with the rolling platform installed intern that should be understood in an interval of 8 mm. to 14 mm., depending on the type of activity surface and of the carrying capacity of the container, being able to this way to use wheels of different diameter and capacity of it loads, in base of the total functional height that should have the inner rolling platform previously according to the optimization of fundamental parameters exposed.

The height functional total of the platform rolling intern is decisive in the operation of the internal mechanism for inclination of the container, then it defines an interval of good securities with those that the mentioned platform can be installed and desinstalada without difficulty, that is to say that tilts without obstacles.

The rigid container, to be able to use the inner rolling platform, their inferior base forms a holder of section location plane-concave, generated starting from the introduction of a spherical segment, that it corresponds to the concave inferior base of the rigid container, inside the one cylinder of sustentation in the floor of the rigid container, penetrating from its base superior up to the ⅔ of their height, and also, he should have a reason adimensional between the longitudes of the rope and the arrow of the spherical segment smaller than 5,25.

This conformation constructive characteristic, similar to that of those recipients to pressure metallic present in the market, it becomes extensive by means of this invention of the inner rolling platform, to all type of rigid containers not pressurized motives that will be able to this way, to improve their use estates.

The basic constructive characteristic of this invention is the interrelation of the selection of geometric parameters optimized regarding those cut: the plane-concave of the holder of location of the container and the rectangular of the cylindrical cupel of the inner rolling platform. Conjunction selective that allows the correct operation of the internal mechanism for inclination of the installation container and extraction of the inner rolling platform, without rising of the container, and that it can be implemented by means of the introduction of the data in a calculation program that gives some functional constructive conformations of both as products final that will be been able to manufacture in any way, either, for shaping, assembling, court, inlaying of a total or mainly metallic material, plastic, vitreous, ceramic, wood or fiber, and I eat rigid containers, of the type barrel, box, palet, can, ark, closet, boat, drum, barrel or tank.

By means of the system that is wanted to be protected it gets, in an easy way and with little effort, to locate the internal rolling platform in the rigid container, inside of and under their positioning receptacle, only, with a slight angle of basculación of the rigid container, without lifting it of the floor, and in the journey gradual of turn of the basculación, the concave section of the base of the positioning receptacle of the rigid container as she goes entering in the central hole of the inner rolling platform, until a moment in that it tilts from the floor toward the concave inferior base, towards the total uprightness of the container, the inner rolling platform returns to the floor and both are installed in the mentioned concave inferior base of the aforementioned rigid container.

With the full uprightness of the rigid container the inner rolling platform it is completely couple and holding from a reliable and stable way to the one rigid container that independently of their load state, both will be able to to make a soft, firm and stable smooth displacement.

The mentioned mechanism also, it acts in inverse sense allowing the extraction of the inner rolling platform installed inside the positioning recptacle of the container, alone by means of a small inclination of the rigid contendor and you proceeds to catch without more the mentioned platform that for the combined action of the concave base of the positioning receptacle of the container and of the central hole of the inner rolling platform, this it is loose without more.

All these previous performances are carried out without any participation external, alone they are consequence of the estates of the improvement of the invention.

The versatility of the system of inner rolling platform will make that all the fitting stocks and separation during the manipulation of the containers, they can be applied to as much as recipients to metallic pressure or without pressure and not metallic, with different forms from simple configurations as the cylindrical one, until the most complex as the elliptic ones or the poliedric.

The process of production of the inner rolling platform goes into it begins with the definition of the endproduct, specified by the constructive configuration, with form of thick disk, when the building supply is plastic mold material or with form of cylindrical cupel, for when the material type of construction, it is cold thin and laminate steel plate, improving the mechanical characteristics for static efforts, in order to resist some concentrations of apparent tensions for the existence of the central hole and the localization in their outlying of the load for compression that it is necessary to support, with a minimum elastic capacity and without permanent deformation, for half of the system of having conformed by not very deep cold inlaying and simple conformation in a single phase, circumstances that facilitate the construction of the dies for such an inlaying type and the level of improvement of the productivity of the press, both therefore, allow a reduction of operative costs.

This way, a resistant endproduct is gotten with high margin of security to the mechanical solicitations of the operative conditions characteristic of the inner rolling platform, so that it makes the transfers of the container with positioning receptacle with or without load, be very reliable, stable, simple, quick and mainly, fewer made an effort.

### DESCRIPTION OF THE DRAWINGS

To complete the description that you this making, and with object of helping to a better understanding of the characteristics of the invention, she accompanies the present descriptive memory, like integral part of the same one, a series of five planes with schematic representations, of illustrative character and not limitative that pick up a prototype model.

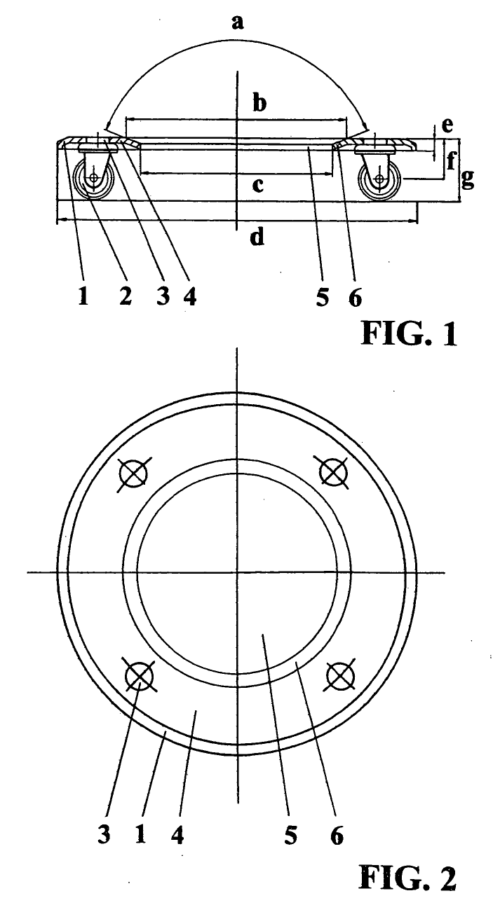

The FIG. 1.—It represents a view of a longitudinal cut in absconder of the inner rolling platform, formed by a cylindrical cupel, obtained by means of an inlaying process, and the directional wheels.

The FIG. 2.—It shows a view in plant superior of the inner rolling platform.

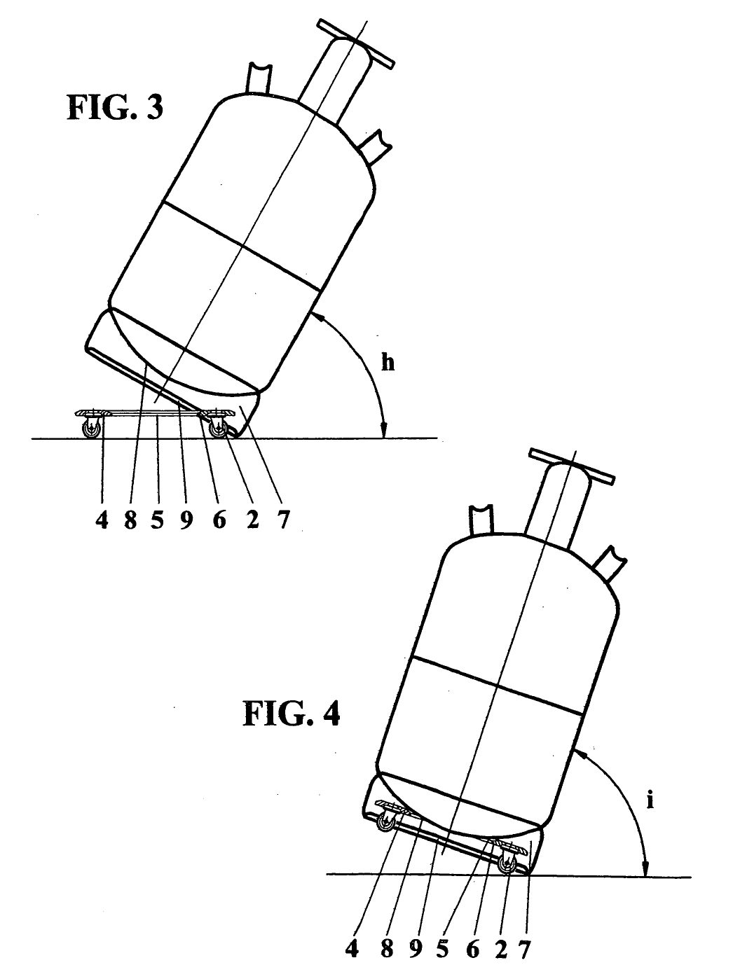

The FIG. 3.—It illustrates a view of a longitudinal section in absconder of the inner rolling platform, obtained by means of shaping, next to the recipient to metallic pressure, in positions that they correspond at the beginning of the installation of the inner rolling platform, or, at the end of the extraction of the one mentioned platform.

The FIG. 4.—It represents a view of a longitudinal section in absconder of the inner rolling platform, obtained by means of shaping, next to the recipient to metallic pressure, in positions that they correspond to the intermission of the installation of the inner rolling platform, or, to the intermission of the extraction of mentioned platform.

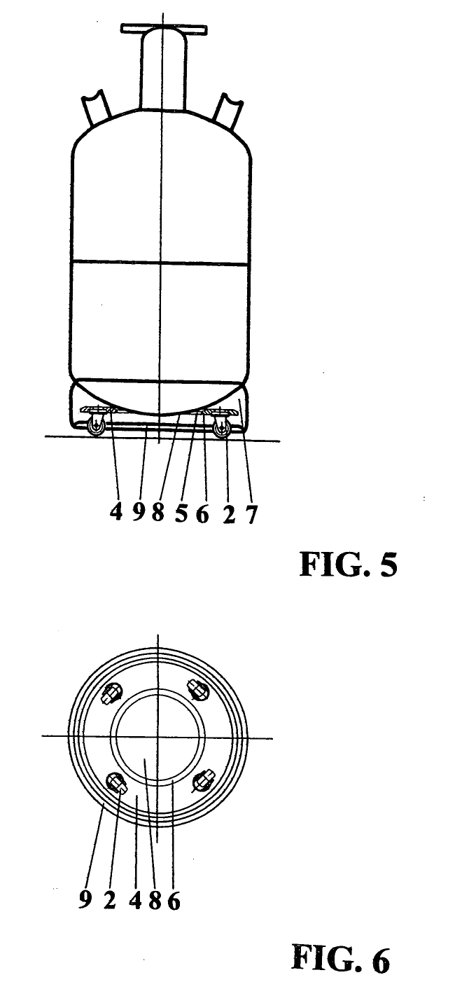

The FIG. 5.—It contains a view of a longitudinal cut in absconder of the inner rolling platform, obtained by means of shaping, next to the recipient to metallic pressure, in positions that they represent the end of the installation of the inner rolling platform, or, the beginning of the extraction of the aforementioned platform.

The FIG. 6.—It represents a view in inferior plant of the inner rolling platform, obtained by means of an inlaying process, next to the recipient to metallic pressure, in the same positions contained in the FIG. 4.

### PREFERABLE REALIZATION OF THE INVENTION

Next it will be made the description of an example peculiar of realization of the invention, in re the enclosed drawings.

Leaving of the existence in the market of containers with positioning receptacle, as the recipients to metallic pressure for liquids or OLG, he will take like reference to these last ones, particularized in a type bottle of butane maidservant (FIGS. 3, 4 and 5) for example of operative realization extrapolable to any process of optimization of the design and production of a rigid container with positioning receptacle and the subsequent process of optimization of the design and production of their corresponding inner rolling platform, adapting their construction geometric parameters to those of the one position receptacle of the mentioned butane bottle (4 and 7 in the FIGS. 3, 4 and 5).

The positioning receptacle of the butane bottle has the dimensions minimum precise so that it is possible the action of the internal mechanism of inclination of the placement container and extraction of a rolling platform appropriate.

The fundamental parameters that define those minimum dimensions (7 and 8 in the FIGS. 3, 4 and 5), they are the spherical segment it penetrates until the ⅔ parts of outlying hoop of support in the floor (9 in the FIGS. 3, 4 and 5) and also, the relationship adimensional between the rope and the arrow of the spherical segment (8 in the FIGS. 3, 4 and 5), it is of 5,19.

The inner rolling platform, for their to enter in the holder of positioning receptacle of the butane bottle, firstly, this last one is inclined, gradual and slightly, up to about 68° on the floor (h in the FIG. 3), using as fulcrum an area of the border of the outlying hoop that supports in the floor (8 and 9 in the FIG. 3) and that it conforms he goes advancing the rising of the bottle, the surface of the fulcrum goes diminishing, until being reduced to a small one arch.

The short necessary journey of this internal mechanism of inclination of the one container, and the continuous support of the container in the floor makes that the effort necessary for their light inclination it is smaller in an order of magnitude.

Next, he catches the inner rolling platform (4 in the FIG. 3), and it locates it to him, without having to specify their location, under the positioning receptacle of the butane bottle (7 and 8 in the FIG. 3), for once finish this positioning, the inclined butane bottle you returns, progressively, to its vertical position (8 in the FIGS. 5 and 6), and to be installed the inner rolling platform (4 and 8 in the FIGS. 5 and 6).

During this journey of turn of the basculación the mechanism acts intern for inclination of the bottle of installation butane and extraction, when the concave inferior base of the butane bottle (8 in the FIGS. 3, 4 and 5) she goes going toward the central hole of the inner rolling platform (5 in the FIGS. 3 and 4), until both contact, on the 80° regarding the floor (i in the FIG. 4), giving beginning to the basculación of the inner rolling platform (4 in the FIG. 4), moment in which has to go happening, with certain looseness due to the possible bumps, for the circular base of the interior border of the outlying hoop of support in the floor of the bottle (4 and 9 in the FIGS. 3, 4, 5 and 6), that saving the short lash, according to the type of outlying hoop of support and condition of use, he/she can end up decreasing the available interior diameter until the 265 mm.

With the inner platform rolling seized to the concave inferior base of the butane bottle (4 in the FIG. 4), the movement of return of the basculación of the continuous butane bottle until the total uprightness (4 in the FIG. 5), being this way, installed the inner rolling platform.

Equally, for the extraction of the inner rolling platform of inside and under the positioning receptacle of the butane bottle (4 and 8 in the FIG. 4), it acts inversely, the mechanism for inclination of the butane bottle of installation and extraction, by means of the geometric conjunction of the central hole and the profile of their inclined area of the internal rolling platform (5 and 6 in the FIG. 5) and the concave inferior base of the butane bottle (8 in the FIG. 5), it allows that, being installed the inner rolling platform, you proceeds to bow the butane bottle together with the inner rolling platform (4 and 8 in the FIG. 4), continuing both inclined ones and embedded until arriving at the 10° on the floor (h in the FIG. 3), moment in which is loose the inner rolling platform, that she will be able to catch, without more, when the butane bottle finds been inclined, up to the 22° on the floor (4 in the FIG. 3) and to return to the vertical one to the bottle of butane.

The essential dimensions of the platform rolling intern consist in that the cylindrical cupel (4 in the FIGS. 1 and 2) it is narrow, with a height of 10 mm. (e in the FIG. 1), and he/she has a diameter operative external maximum of 260 mm. (d in the FIG. 1).

Likewise, the inclined central area (6 in the FIGS. 1 and 2) she has a height of 10 mm. and some 68° of inclination in reason of the vertical one (a in the FIG. 1) and the dimensions of their diameters are; the external one (b in the FIG. 1) of 160 mm. and the intern (c in the FIG. 1) of 140 mm.

The other essential parameter of the inner rolling platform is the height functional total (g in the FIG. 1), determined by their thickness that in this case it is steel plate of 1,2 mm., and for the total height of the directional wheels of 44 mm., and that they go inserted, perpendicularly and distributed symmetrically, in the crown area to circulate of the cylindrical cupel (2 and 3 in the FIGS. 1 and 2).

This height of the wheels this referred to the dimensions of several parameters; such as, the height of the wheel support (f in the FIG. 1) of 34 mm., and the height free of the border of the butane bottle to the floor with the inner rolling platform placed (FIG. 4) of 14 mm., referred to an internal diameter of the central hole (5 in the FIGS. 1 and 5) of 140 mm.

This optimized group of constructive parameters of the inner rolling platform, it allows him to settle in the concave base of the position receptacle (8 and 5 in the FIGS. 3 and 4), when getting up and to tilt freely and without obstacles on their interior wheels (2 in the FIG. 3).

The optimization of the selection of geometric parameters and characteristic construction, previously defined, she makes that the conjunction geometric among the sections; the planeconcave of the positioning receptacle of the one container (7 and 8 in the FIGS. 3, 4 and 5) and inclined of the central hole of the circular crown of the internal rolling platform (5 in the FIGS. 3, 4 and 5), allow that this last one rises and tilt, during their action of it couples (4 in the FIGS. 3, 4 and 5), inside of and under, of the positioning receptacle of the bottle of butane, during its, also, functional basculación (7 and 8 in the FIGS. 3 and 4).

The inner rolling platform sustains and it holds, in a reliable and sure way to the butane bottle that through a wide band of their inferior base, to circulate and concave (8 in the FIG. 4), she settles on the inclined profile of the hole central of the platform (6 in the FIG. 4) that with an inclination in that area of around 68° in reason of the vertical one, being same the slope of both establishment surfaces, it is this way located, without slips and without touching the inferior border of the bottle in the floor, being able to, both to move easily.

This way, when not having to lift the butane bottle that when this loaded one in their entirety to position it in the conventional rolling platforms is very difficult and painful, the realization of a great effort is avoided.

The system, according to the present invention, of the internal mechanism for inclination of the fitting container and of loose of the inner rolling platform in the rigid container with positioning receptacle, it allows to enlarge its use to all type containers, to those that at this time are manufactured for storage and transport of pressurized liquids, LGO and other liquefied gases, and also, to those that are manufactured pertinent from now on with the conformation basic characteristic of the positioning receptacle.

The optimized conjunction of all the essential parameters of the inner rolling platform to the positioning receptacle of the butane bottle it allows their placement and extraction in this last one to be carried out in way easy, reliable, sure and without almost effort, by means of the internal mechanism for inclination of the butane bottle, only inclining it 22° from the floor in their position vertical initial.

The materials and the type manufacturing employees will be independent of the one object of this invention, this way, the inner rolling platform and the rigid container they will be been able to manufacture for inlaying, hydroforming, shaping, assembling or court of a material, total or mainly, metallic, plastic, vitreous, ceramic, wood or fiber, and finally, they will have other forms different to the circular one, as the elliptic one or the polygonal one.

1. An inner rolling platform that can receive and can enable extraction with a slight basculación only, a whole rigid container, that is supported on a floor without having to lift the container, the platform including an internal mechanism for inclination of the rigid container having an appropriate positioning receptacle, the platform having a central hole;
in the journey of turn of the basculación, a convex inferior base of a container is positioned close to the central hole of the inner rolling platform, initially, wherein a periphery of the central hole is shaped such that at a moment of first contact between the container and the rolling platform, the platform rises until contacting the convex inferior base of the container, and together they thereafter both return to the floor and they are installed, already with the now vertical container in the platform; and in an inverse sense, extraction of the inner rolling platform installed under the inferior base convex of the container is alone by a small inclination of the container which catches the inner rolling platform and, for the combined inverse action of the convex inferior base of the one container and of the central hole of the inner rolling platform, after tilting, the container becomes loose in the floor, without more;

2. Inner rolling platform according to claim 1, wherein the inner rolling platform is comprised of a support base with cupel form cylindrical, of little depth having a diameter at a maximum of 10% smaller than the interior diameter of the plane base of of a floor of the container; the cylindrical cupel is disposed in the center of the support base and the cupel has a wide hole with a functional minimum diameter of at least half of the diameter of the cupel, and including a radially wide, inclined, outlying area, equal to the inferior base convex of the container and with a difference between their respective diameters exterior and interior of at least 12%.

3-4. (canceled)

5. Inner rolling platform of claim 2, wherein the platform includes a functional height total including height of the grosor of the constructive material of the cylindrical cupel, and the height of establishment of the inner rolling platform in the base convex of the container, until 20% of the arrow of their segment of a circle, and the height free of the inferior border of the container to the floor, with the platform rolling installed in an interval of 8 mm. to 14 mm.

6. In combination, an inner rolling platform according to claim 1 and a rigid container for use with the inner rolling platform, the base of the platform forming a positioning receptacle of plane-concave section, generated starting from the introduction of a spherical segment that corresponds to the convex inferior base of the rigid container, inside a cylinder defining the floor of the rigid container, penetrating from the superior base up to the ⅔ of their height, and also, the platform has a dimension among the longitudes of the rope and the arrow of the spherical segment smaller than 5.25.
